(19) United States
(12) Patent Application Publication
(10) Pub. No.: US 2010/0244467 A1
(43) Pub. Date: Sep. 30, 2010

(54) DEVICE FOR LOCKING AT LEAST ONE DOOR ELEMENT IN AN OPENING TO A SPACE

(75) Inventor: Sten Asen, Varmdo (SE)

Correspondence Address: VENABLE LLP, P.O. BOX 34385, WASHINGTON, DC, 20043-9998, US

(73) Assignee: Lockia AB, Nacka (SE)

(21) Appl. No.: 12/440,441

(22) PCT Filed: Sep. 5, 2007
(86) PCT No.: PCT/SE07/50627

§ 371 Date: Jun. 11, 2010

(30) Foreign Application Priority Data
Sep. 6, 2006 (SE) 0601828-7

(51) Int. Cl. E05C 19/00

(52) U.S. Cl. 292/259 R

(57) ABSTRACT

A device for locking at least a door element in an opening to a space. The device includes a locking mechanism including a locking bar located on the inside of the door element. A protective housing includes a first part attached to the inside of the door element and a second part attached to an inside of an adjacent element. A protective plate is attached on the inside of the door element in a position such that the protective plate covers a gap between the door element and the adjacent element in connection with the extension of the locking bar over the gap when the locking bar is in a locked position. The parts of the protective housing are designed such that a gap between the parts of the protective housing does not coincide with the gap between the door element and the adjacent element.

### TECHNICAL FIELD OF THE INVENTION AND PRIOR ART

The present invention relates to a device for locking at least a door element in an opening to a space, wherein the device comprises a locking mechanism which comprises an operating member arranged on an outside of the door element, a locking bar arranged on an inside of the door element, a motion transmission mechanism adapted to transmit motions from the operating member to the locking bar, and a lock adapted to lock the locking bar when it is in a locking position, in which position the locking bar prevents an opening of the door element, and a protective housing which comprises a first part attached to the inside of the door element and a second part attached to an inside of an adjacent element which parts are adapted to commonly form a channel in which the locking bar is movably arranged.

By a door element is meant a door, cover or the like which may be used for closing an opening to a space of an arbitrary kind. In many cases, the locking mechanism, which locks a door element, is countersinked in a recess in the door element. Such a recess results in a local reduction of the thickness of the door element and thus a reduced strength. Such local weakenings in the door element can be utilised by thieves.

Other kinds of locking mechanisms are arranged on the outside the door elements. Such locking mechanisms may, for example, comprise a locking bar, which has a first end attached to the door element and a second end attached to an adjacent stationary wall element, for example, by means of a pad lock. Such externally arranged locking mechanisms are within reach for tools and they can, for example, be cut off by a hydraulic cutter. Alternatively, one end of a heavy wire can be attached to the locking bar and the other end to a vehicle, whereupon the vehicle can pull out the locking bar.

Locking devices, which substantially have its locking mechanism arranged on the inside of a door element, provides the best protection against burglary. However, these locking devices do not eliminate the risk that a thief hides inside or enters a space, which, for example, may be a storage space or a space in a container. Thereafter, the thief can dismount the locking device from the inside. Alternatively, the thief may enter, for example, a storage room, via a window, with the purpose of from the inside dismounting the locking mechanism to facilitate the possibility to take out the stolen goods.

WO 00/70173 shows a device for locking two door elements by a locking mechanism mainly arranged on the inside of the door elements. Thus, a very good protection is obtained against manipulation of the locking mechanism from the outside. A protective housing encloses completely the locking mechanism, which is located on the inside of the door element. The protective housing comprises a first part attached on the inside of one of the door elements and a second part attached on the inside of the other door element. A very good protection against manipulation of the locking mechanism from the inside is also obtained with such a protective housing. However, the device described here has the drawback that the gap between the two door elements coincides with the gap between the parts of the protective housing. Thus, it is not impossible to insert a cutting tool from the outside and into the common gaps and cut the locking bar. It is true that the gap is prevented from encroachment in connection to the locking bar by a smaller protective plate attached on the outside of one of the door elements. However, this protective plate is easy accessible for manipulation when it is located on the outside of the door elements. Furthermore, the protective plate covers only a small part of the door gap.

### SUMMARY OF THE INVENTION

The object of the present invention is to provide a device for locking a door element in an opening to a space where it is extremely difficult for a thief to force the locking mechanism both from the outside and from the inside of the door element.

This object is achieved by the initially mentioned device which is characterised in that it comprises a protective plate attached on the inside of the door element or on the inside of the adjacent element in a position such that it covers a gap between the door element and the adjacent element in connection with the extension of the locking bar over the gap when it is in a locked position, wherein the parts of the protective housing are designed such that a gap between the parts of the protective housing does not coincide with the above mentioned gap. The protective plate may be attached on the inside of one of said elements by means of, for example, welding, screws, rivets etc. Since the protective plate is attached on the inside of the space, it has a protected position, which substantially prevents it from being gripped and removed from its protected position. In order to cut the locking bar from the outside by a tool, such as a saw blade or a crosscut saw, it is required that the tool first works through the protective plate before it can reach the locking bar. By manufacturing the protective plate in a material having very good strength properties and in a suitable thickness, such a cutting work is made significantly more difficult. Since the gap between the parts of the protective plate also has a position such that it does not coincides with the door gap, such a cutting work is made even more difficult since the tool also has to cut through the protective housing in order to be able to cut the locking bar. Advantageously, the protective housing is also manufactured of a material having very good strength properties. Thus, it is extremely difficult and laboriously for a thief to force the locking mechanism from the outside.

According to a preferred embodiment of the present invention, the protective plate has an extension along the whole length of the gap. Thus, it is not possible to insert a cutting tool in any place of the gap for enabling manipulation of the protective plate and the locking mechanism. At least one of the parts of the protective housing may comprise a plane portion adapted to be attached to the inside of one of said elements and a portion adapted to form a part of said channel for the locking bar. The parts of the protective housing may be formed by a profile tube, which comprises at least a plane portion and a channel shaped portion. Thus, the protective housing may be given an uncomplicated shape and manufactured to a relatively low cost. Advantageously, the protective housing is adapted to enclose all parts of the locking mechanism, which are arranged on the inside of said element. Since no parts of the locking mechanism are reachable without forcing the protective housing, the locking mechanism is protected from manipulation from the inside in a very effective manner. Such a protective housing has also the property that it protects the movable parts of the locking mechanism from being blocked on the inside of the door element by loosely arranged goods, which can be the case, for example, in a container.

According to another preferred embodiment of the present invention, the protective housing is attached by means of non-dismountable attachment means. Thus, it is considerably more difficult for a thief to dismount the protection casing from the inside in order to reach and break open the locking mechanism. Such non-dismountable attachment means may be bolts having heads, which are preferably depressed in a mounted state and a shape such they are difficult to grip. Such non-dismountable attachment means may also comprise rivets or weld joints. Said adjacent element is a second openable door element or a rigid wall element. When double door elements are used, the two door elements can be locked together by means of the locking bar. For a single door element, it is suitable that the locking bar locks the door element in relation to an adjacent rigid wall element. Advantageously, both the operating member and the lock are attached to the door element. Thus, such a door element can be used as a single door element closing an opening or as a door element in a double door arrangement.

According to another preferred embodiment of the present invention, it comprises coupling means arranged to restrict the force, which the operating member, via the motion transmission mechanism, is allowed to transmit to the locking bar. Thus, the risk is prevented that a thief, by means of suitable tools from the outside, provides such a heavy force onto the operating member that the locking bar is displaced and deforms the locking mechanism. Such coupling means may comprise a suitable kind of safety clutch. Advantageously, the motion transmission mechanism is arranged to transmit a rotary motion from the operating member to a reciprocal displacement motion of the locking bar. Advantageously, the operating member is a rotatable wheel or crank arranged on the outside of the door element. The operating member is connected to a suitable motion transmission mechanism, which transforms the rotary motion of the operating members to a reciprocal motion of the locking bar between said first and second position. Advantageously, the motion of the locking bar is linear.

According to another preferred embodiment of the present invention, the locking bar has a front portion provided in a displacement direction which front portion comprises at least one chamfering. By such a chamfering, the risk is eliminated that the locking bar tilts and jams during its displacement motion in the channel. Especially when the protective housing consists of two pieces and the channel is divided, such a chamfering brings about that the parts of the channel are centred to a desired position in relation to each other during the displacement motion of the locking bar.

According to another preferred embodiment of the present invention, the lock comprises a bolt, which is insertable in a recess in the locking bar in order to lock the locking bar in said second position. Advantageously, such a lock comprises a lock body extending through the door. On the outside of the door element, a key activates the lock so that the bolt, which is provided on the inside of the door, is displaced in or out of said recess. Preferably, the lock is a 9-lever tumbler lock. Such a lock is a high security lock, which is approved to be used in safes. The key of the lock is protected against an unauthorised copying. Furthermore, the lock has a barrier, which prevents insertion of optical means for photographing the inside with the purpose of manufacturing an unauthorised key.

According to another preferred embodiment of the present invention, the second part of the protective housing comprises a channel for receiving the locking bar, which has a larger vertical extension than the channel of the first part of the protective housing. Advantageously, the second part of the protective housing is applied such that the locking bar provides a play both on an upper side and on a lower side in the channel of the second part of the protective housing. Such a play prevents that the locking bar jams into the second protective housing if the door elements would provide a relative motion in relation to each other in a locked state. The second part of the protective housing may comprise a channel for receiving the locking bar, which internally has been provided with thin plate-like elements in order to adapt the breadth of the channel to the breadth of the locking bar. For example, thin plate-like elements in the form of shims may be applied inside the channel such that it obtains a substantially corresponding breadth as the locking bar. It is important that the channel has a breadth, which is adapted to the breadth of the locking bar such that no unnecessary play arises in this direction. If the play in this direction is too large, the gap between door elements can be wider and breaking tools can be inserted between door elements.

### BRIEF DESCRIPTION OF THE DRAWINGS

In the following, preferred embodiments of the invention are described as examples with reference to the attached drawings, on which:

FIG. 1 shows a part of a container provided with two pivotally arranged door elements, which are lockable by a locking mechanism according to the present invention,

FIG. 2 shows the door elements in FIG. 1 from the inside of the container,

FIG. 3 shows the locking mechanism in FIG. 2 more in detail,

FIG. 4 shows a cross section view in the plane A-A in FIG. 3 of the motion transmission mechanism,

FIG. 5 shows a locking mechanism according to a second embodiment of the invention and

FIG. 6 shows a locking mechanism according to a third embodiment of the invention.

### DETAILED DESCRIPTION OF PREFERRED EMBODIMENTS OF THE PRESENT INVENTION

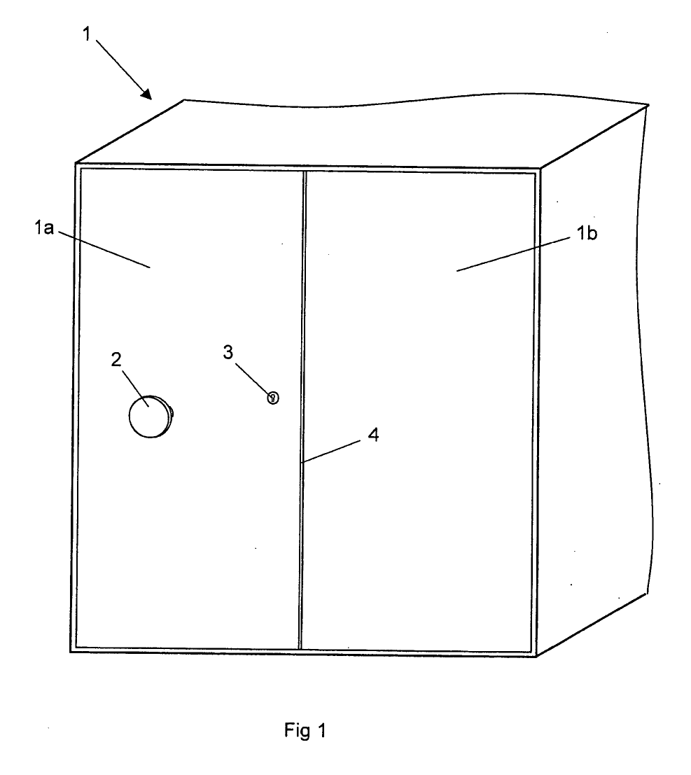

FIG. 1 shows a part of a container 1 having an opening, which is closeable by means of a first door element 1a and a second door element 1b. A turnable operating member 2 is arranged on the outside of the first the door element 1a. The operating member 2 consists a part of a locking mechanism which mainly is located on the inside of the door elements 1a, 1b. The operating member 2 can also be used as a handle in order to open and close the first the door element 1a. The first door element 1a also comprises a lock 3. A front portion of the lock 3, which comprises a keyhole, is visible on the outside of the door element 1a. A more or less narrow gap 4 is inevitably formed between door elements 1a, b when they are in a closed position.

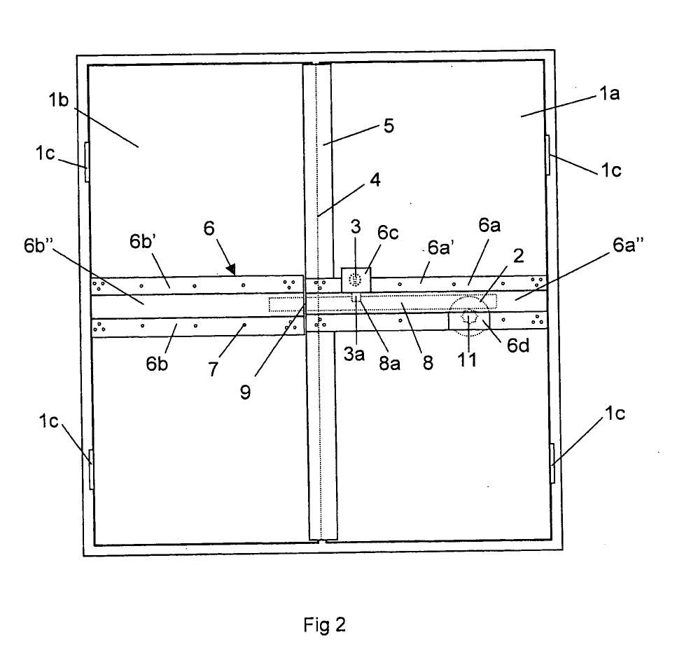

FIG. 2 shows the door elements 1a, b from the inside of container 1. The door elements 1a, b are shown in a closed and locked position. The door elements 1a, b are pivotally attached to the container by means of a number of gangways 1c or similar articulated elements. An elongated protective plate 5 is fixedly arranged on the inside of the first the door element 1a in a position such that it substantially covers the whole gap 4 between the door elements 1a, 1b when they are in the closed position. The protective plate 5 can be attached on the first door element 1a by means of, for example, welding or screws. A protective housing 6 is adapted to enclose all parts of the locking mechanism which are arranged on the inside of the door elements 1a, b. The protective housing 6 comprises a first part 6a which is attached on the inside of the first the door element 1a and a second part 6b which is attached on the inside of the second the door element 1b. The parts of the protective housing 6a, b are here manufactured of profile tubes. The profile tubes comprise upper and lower portions forming base plates 6a′, b′ which are attached to the inside of de respective door elements 1a, 1b. The base plates 6a′, b′ can be attached by means of rivets 7 or special bolts, having a head shape, which minimise the possibility to grip them with a tool. Alternatively, other kinds of non-dismountable attachment means can be used. The base plates 6a′, b′ can, for example, be welded to the insides of the respective door elements 1a, 1b. Furthermore, the profile tubes comprise an intermediate portion 6a″, b″ adapted to form an inner cavity, which encloses the locking mechanism. When the door elements 1a, b are in the closed position, the inner cavities of the intermediate portions 6a″, b″ form a continuous elongated channel adapted to enclose a displaceable locking bar 8. A more or less narrow gap 9 is inevitably formed in the area between the parts of the protective housing 6a, 6b. The protective housing 6 also comprises a part 6c arranged to enclose the portion of the lock 3 located on inside of the door element 1a. Finally, the protective housing 6 comprises a part 6d enclosing a gear wheel 11 of the motion transmission mechanism.

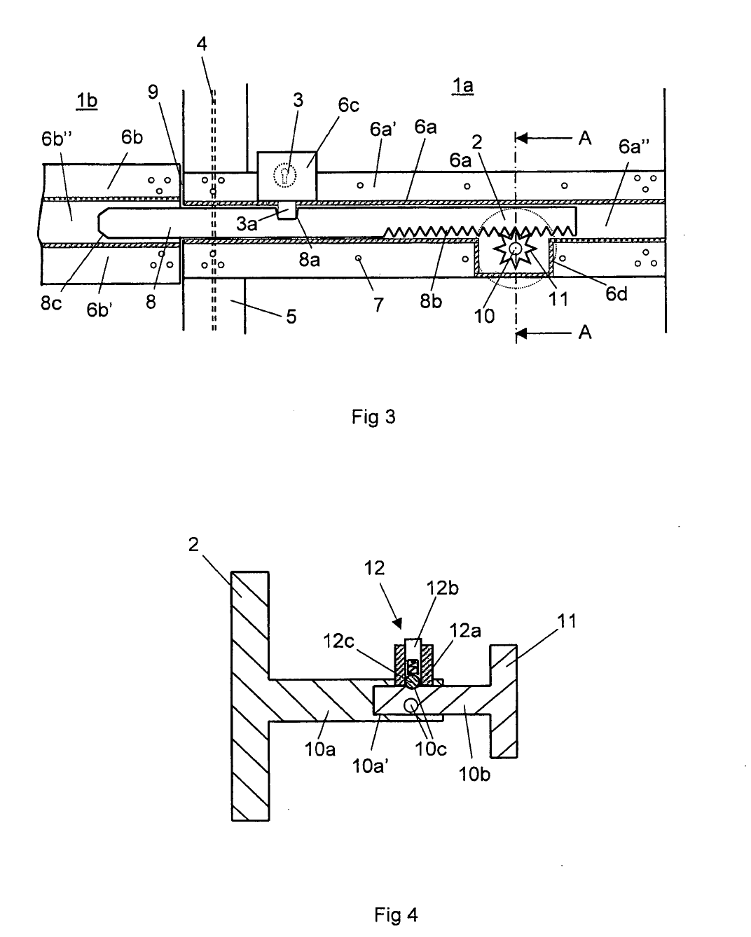

The above-mentioned locking mechanism is clearest shown in FIG. 3. Consequently, the operating member 2 is, via a motion transmission mechanism, connected to the locking bar 8. The motion transmission mechanism is designed such that it transmit the turning motions of the operating members 2 to linear displacement motions of the locking bar 8 in said channel formed by the protective housing 6. The motion transmission mechanism comprises a shaft 10 having an extension through the first the door element 1a. The shaft 10 is adapted to transmit turning motions of the operating member 2 to a gear wheel 11 which is in engagement with a toothed portion 8b of the locking bar 8. When the gear wheel 11 rotates, it displaces the locking bar 8 in the channel via the toothed portion 8b. The locking bar 8 is displaceable between a first position when it solely is located in the first part 6a of the protective housing and a second locking position when the locking bar 8 also extends into the second part of the protective housing 6b. In this second locking position, the locking bar 8 connects the door elements 1a, 1b to each other such that they not can be open. The locking bar 8 comprises a recess 8a, which in the locking position of the locking bar 8 is adapted to be located substantially straight below the lock 3. The lock 3 comprises a displaceable bolt 3a, which is insertable in the recess 8a in order to lock the locking bar 8, when it is located in the locking position. In order to position the locking bar 8 in the locking position, the locking bar 8 can comprise a not shown stop surface adapted to get in engagement with a stop surface in the channel when the locking bar 8 has reached the locking position. When the locking bar 8 is locked, it is not possible to displace it by means of the operating member 2.

A front portion of the locking bar 8 has chamfered portions 8c. By means of such chamfered portions 8c, the risk is eliminated that the locking bar 8 is tilted and jams during its displacement motion in the channel. Especially when the protective housing 6 is in two parts and the channel divided, such chamfered portions 8c services to guide the locking bar 8 into the receiving channel part during the displacement motion of the locking bar 8. This is a great help if the door elements 1a, 1b have been warped. The intermediate portion 6b″ of the second part 6b of the protective housing has a receiving channel having a larger extension in the vertical direction than the channel the first part 6a of the intermediate portion 6a″ of the protective housing. Thus, the locking bar 8 can be given a play both on the upper side and the lower side in the channel of the second part of the protective housing 6b. Such a play prevents that the locking bar 8 jams inside the second part of the protective housing 6b if, for example, a container 1, which always have a certain flexibility, are placed on an uneven ground such that the door elements 1a, b provide a relative motion in relation to each other in a locked state. On the other hand, it is important that the channel of the second part of the protective housing 6b has a breadth adapted to the breadth of the locking bar 8 such that no unnecessary play arises in this direction which coincides with the motion directions of the door elements 1a, b. If the play in this direction would be too large, there is a risk that breaking tools can be inserted between the door elements 1a, b. In order to provide a small and functional play in this direction between the locking bar 8 and the sidewalls of the channels of the second part of the protective housing 6b, thin plate-like elements such as shims can be applied inside the channel. This is suitably used in connection with the mounting of the locking device in the container 1.

FIG. 4 shows a cross section area through the plane A-A in FIG. 3. The shaft 10, which transmits the turning motions of the operating member 2 to the gear wheel 11, is in two parts. The shaft 10 comprises a first part 10a fixedly attached to the operating member 2 and a second part 10b fixedly attached to the gear wheel 11. The first part 10a of the shaft comprises an axial recess 10a′ in which the second part 10b is insertable.

Furthermore, the shaft parts 10a, b are connected to each other by means of safety clutch 12. The safety clutch 12 comprises a casing 12a, which is attached to the first part 10a in an outer radial position of the recess 10a′. The casing 12a is provided with a through hole having an internal thread. An elongated element 12b having an external thread is adapted to be treaded into the through hole of the casing 12a. The elongated element 12b comprises at a lower end a spring loaded ball 12c, which, in a mounted state, is adapted to extend a shorter piece into the recess 10a′. The second part of the shaft 10b comprises one or several periphery depressions 10c for receiving the ball 12c. As long as the ball 12c is located in such a depression 10c, turning motions can be transmitted from the operating member 2 to the gear wheel 11 via said shaft parts 10a, b. If a too heavy force acts on the operating member 2, the ball 12c is pressed out of the depression 10c. Thus, the force that the operating member 2 can transmit to the locking bar 8 is restricted. By means of a safety clutch 12, it is not possible to deform the lock 3 by supplying a too heavy force on the locking bar 8 by the operating member 2.

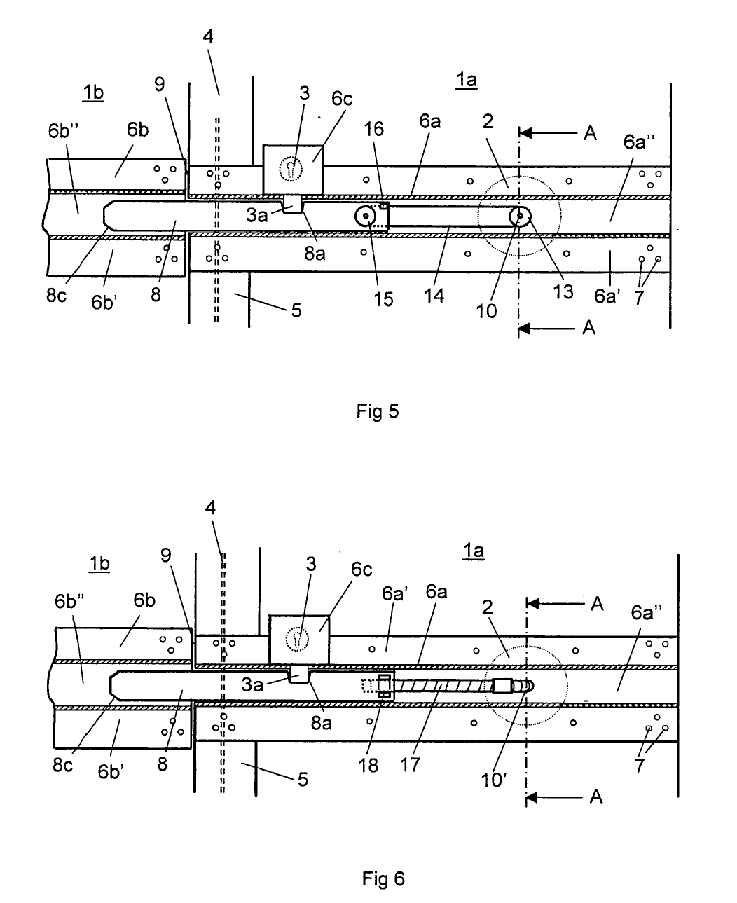

FIG. 5 shows an alternative embodiment of the motion transmission mechanism extending between the operating member 2 and the locking bar 8. In this embodiment, the turning motions of the operating member 2 are transmitted, via a shaft 10, to a first pulley 13. The pulley 13 transmits its rotary motion to a cord 14. The cord 14 forms an endless loop, which except said first pulley 13 also extend around the periphery of a second pulley 15. The second pulley 15 has a shaft fixedly carried in the protective housing 6. The cord 14 is fixedly attached to the locking bar 8 via an attachment 16. When the pulley 13 rotates, the cord 14 is displaced along said endless loop. Thereby, the attachment 16 in the locking bar 8 is displaced between the positions of the pulleys 13, 15. Thus, the locking bar 8 can be displaced between said first and second position. The locking bar 8 is partly hollow so that it can be moved to and back pass the second pulley 15 and partly encase the cord 14. The remaining parts of the locking mechanism correspond substantially to the ones shown in FIG. 3. Alternatively, the pulleys 13, 15 can be replaced by a chain wheel and the cord by a chain.

FIG. 6 shows a further alternative embodiment of the motion transmission mechanism extending between the operating member 2 and the locking bar 8. In this embodiment, turning motions of the operating members 2 are transmitted, via a flexible shaft 10′, to a threaded rod 17. A nut 18 is fixedly arranged in the rear end of the locking bar 8. By the rotary motion of the threaded rod 17, the nut 18 and the locking bar 8 obtains a reciprocal linear motion when the operating member 2 is turned. The locking bar 8 is also here partly hollow in order to allow the insertion of the threaded rod 17 during its displacement motion. Remaining parts of the locking mechanism in FIG. 6 correspond substantially to the ones shown in FIG. 3.

The motion transmission mechanism can as a further alternative comprises a worm gear for transmitting the turning motion of the operating member 2 from the shaft 10′ to, for example, a threaded rod 17. Advantageously, the lock 3 shown on the figures comprises a 9-lever tumbler lock of the brand FAS. This lock is a high safety lock, which is approved for safes. Furthermore, the lock 3 has a built-in protection, which prevents insertion of fibre optical equipment. Thus, photographing of the lock internally via the keyhole in order to produce a false key is prevented.

The protective housing 6 is adapted to enclose all moveable parts of the locking mechanism arranged on the inside of the door elements 1a, b, which makes it very difficult to manipulate or deform the locking mechanism from the inside. The protective plate 5 is attached in a position such that it covers the whole gap 4 between door elements 1a, b. Since the protective plate 5 is attached on the inside of the gap 4, it has a protected position which makes that it substantially cannot be gripped from the outside and removed from its protected position. Consequently, in order to cut the locking bar 8 from the outside, it requires first that the tool works through the protective plate 5. By manufacturing the protective plate 5 in a very hard metal material, such a cutting work is essentially more difficult. Since the protective plate 5 is attached to the door element 1a they form a connected unit. Thus, the first part 6a of the protective housing can be attached to this connected unit. Thus, the first part 6a of the protective housing can be given an extension beyond the edge portion of the first door element 1a, which together with an edge portion of the second door element 1b define said gap 4. Thus, a gap 9 is obtained in a connecting area between the parts of the protective housing 6a, b which has a displaced position in relation to the gap 4 between the door elements 1a, b. Since the gap 9 between the parts of the protection housing 6a, b has a position such that it does not coincides with the door gap 4, the above-mentioned cutting work is further more difficult since the tool also has to cut through of walls of the first part of the protective housing 6a in order to be able to cut the locking bar 8. Since the protective housing 6 also is manufactured of a material having very good strength properties, it is substantially impossible for a thief to cut the locking bar 8 from the outside.

The present invention is not restricted to the embodiments described in the figures, but may be varied freely within the scope of the claims.

1. A device for locking at least a door element in an opening to a space, the device comprising:
a locking mechanism comprising an operating member located on an outside of the door element,
a locking bar located on an inside of the door element,
a motion transmission mechanism adapted to transmit motions from the operating member to the locking bar,
a lock adapted to lock the locking bar when the locking bar is in a locking position, wherein in the locking position the locking bar prevents an opening of the door element,
a protective housing comprising a first part attached to the inside of the door element and a second part attached to an inside of an adjacent element, wherein the first part and second part of the protective housing are adapted to commonly form a channel in which the locking bar is movably arranged,
a protective plate attached on the inside of the door element or on the inside of the adjacent element in a en position such that the protective plate covers a gap between the door element and the adjacent element in connection with the extension of the locking bar over the gap when the locking bar is in a locked position, wherein the parts of the protective housing are designed such that a gap between the parts of the protection housing does not coincide with the gap between the door element and the adjacent element.

2. The device according to claim 1, wherein the protective plate has an extension along the whole gap.

3. The device according to claim 1, wherein at least one of the first part and second part of the protective housing comprises at least a plane portion adapted to be attached to the inside of one of said element and a portion adapted to form en a part of said channel for the locking bar.

4. The device according to claim 1, wherein the protective housing is adapted to enclose all parts of the locking mechanism arranged on the inside of the elements.

5. The device according to claim 1, wherein the protective housing is attached by a non-dismountable attachment.

6. The device according to claim 1, wherein said adjacent element is a second openable door element or a rigid wall element.

7. The device according to claim 1, wherein both the operating member and the lock are attached to the door element.

8. The device according to claim 1, further comprising:
a coupling adapted to restrict a force which the operating member, via the motion transmission mechanism, is allowed to transmit to the locking bar.

9. The device according to claim 1, wherein the motion transmission mechanism is arranged to transmit a rotary motion of the operating member to a reciprocal displacement motion of the locking bar.

10. The device according to claim 8, wherein the locking bar comprises a front portion comprising at least one chamfering.

11. The device according to claim 1, wherein the lock comprises a displaceable bolt which is insertable in a recess in the locking bar in order to lock the locking bar in said locking position.

12. The device according to claim 1, wherein the lock comprises a 9-lever tumbler lock.

13. The device according to claim 1, wherein the second part of the protective housing comprises a channel for receiving the locking bar, which has a larger extension in a vertical direction than the channel of the first part of the protective housing.

14. The device according to claim 1, wherein the second part of the protective housing comprises a channel for receiving the locking bar, which has been provided internally with thin plate-like elements in order to adapt the breadth of the channel to the breadth of the locking bar.
